(19) United States
(12) Patent Application Publication
(10) Pub. No.: US 2022/0138783 A1
(43) Pub. Date: May 5, 2022

(54) Discrete Choice Hotel Room Demand Model

(71) Applicant: Oracle International Corporation, Redwood Shores, CA (US)

(72) Inventors: Andrew VAKHUTINSKY, Sharon, MA (US); Natalia KOSILOVA, State College, PA (US)

(21) Appl. No.: 17/083,905

(22) Filed: Oct. 29, 2020

(51) Int. Cl. G06Q 30/02; G06Q 50/12; G06Q 10/06; G06Q 10/04; G06Q 10/02; G06N 5/02; G07C 9/00

(52) U.S. Cl. CPC G06Q 30/0206; G06Q 50/12; G06Q 10/067; G07C 9/00857; G06Q 10/02; G06N 5/02; G06Q 10/04

(57) ABSTRACT

Embodiments model the demand and pricing for hotel rooms. Embodiments receive historical data regarding a plurality of previous guests and generate a multinomial logit (“MNL”) model with demand shock variables, the demand shock variables expressed using MNL utility parameters. Embodiments estimate the MNL utility parameters using a likelihood maximization and determine demand shock parameters using the estimating the MNL utility parameters. Embodiments then predict a future demand of the hotel rooms based on the demand shock parameters.

### FIELD

One embodiment is directed generally to a computer system, and in particular to a computer system that generates a hotel room demand model.

### BACKGROUND INFORMATION

Revenue management is the process of dynamically adjusting prices of goods or services in response to changes in market conditions or changes in supply conditions. Revenue management processes were pioneered by the passenger airline industry and have been imitated by other industries such as cargo airlines, hotels, car rentals, shippers, advertisement brokers and others.

A very common application of revenue management relates to service providers who are taking reservation for “date-constrained services”. Date-constrained services involve the imposition of transaction-specific limits on the date when the buyer may use the services they purchase. Examples of such a restrictions include specified arrival and departure dates for an airline reservation as well as specified check-in and check-out dates for a hotel reservation. The time restrictions make it particularly difficult to estimate demand and then determine optimized pricing that maximizes revenue/profit for date-constrained services, particularly in the hotel industry.

### SUMMARY

Embodiments model the demand and pricing for hotel rooms. Embodiments receive historical data regarding a plurality of previous guests and generate a multinomial logit (“MNL”) model with demand shock variables, the demand shock variables expressed using MNL utility parameters. Embodiments estimate the MNL utility parameters using a likelihood maximization and determine demand shock parameters using the estimating the MNL utility parameters. Embodiments then predict a future demand of the hotel rooms based on the demand shock parameters.

### BRIEF DESCRIPTION OF THE DRAWINGS

FIG. 1 is a graph that illustrates price endogeneity for hotel rooms.

FIG. 2 is a block diagram of a computer server/system in accordance with an embodiment of the present invention.

FIG. 3 is a flow diagram that illustrates the functionality of the room demand model module of FIG. 2 in accordance to embodiments.

### DETAILED DESCRIPTION

Embodiments include a novel demand modeling system adapted to predict demand for different classes of hotel rooms based on room prices and features. The prediction can be calibrated with the available information about the expected demand on particular dates. Embodiments use the demand modeling to determine optimized pricing for the hotel rooms. To consistently estimate the underlying demand model in the presence of price endogeneity, embodiments implement a multinomial logit model that includes time-fixed effects. Embodiments correct for the possible time shocks that might be driving prices and demand in the same direction, and also provide an intuitive way to calibrate the demand prediction if some information about such future shocks is available.

Embodiments correct for price endogeneity, which is a widely acknowledged problem in the hotel demand estimation context. Failure to correct for endogeneity results in biased estimates. The price endogeneity occurs when the explanatory variables in the model are correlated with some unobserved factors that might influence the outcome variable of interest. The most notable example of price endogeneity in the hotel industry context is endogenous room prices, as the usual practice for hotel managers is to set higher prices for the periods with high anticipated demand (weekends, holidays, vacation times, etc.) and lower prices when it is expected that the demand will relatively low. If price sensitivity is estimated without accounting for endogeneity, the price sensitivity coefficient might be severely underestimated and might even have the wrong (positive) sign, as the model would conclude that on average higher demand corresponds to the periods with higher prices and vice-versa.

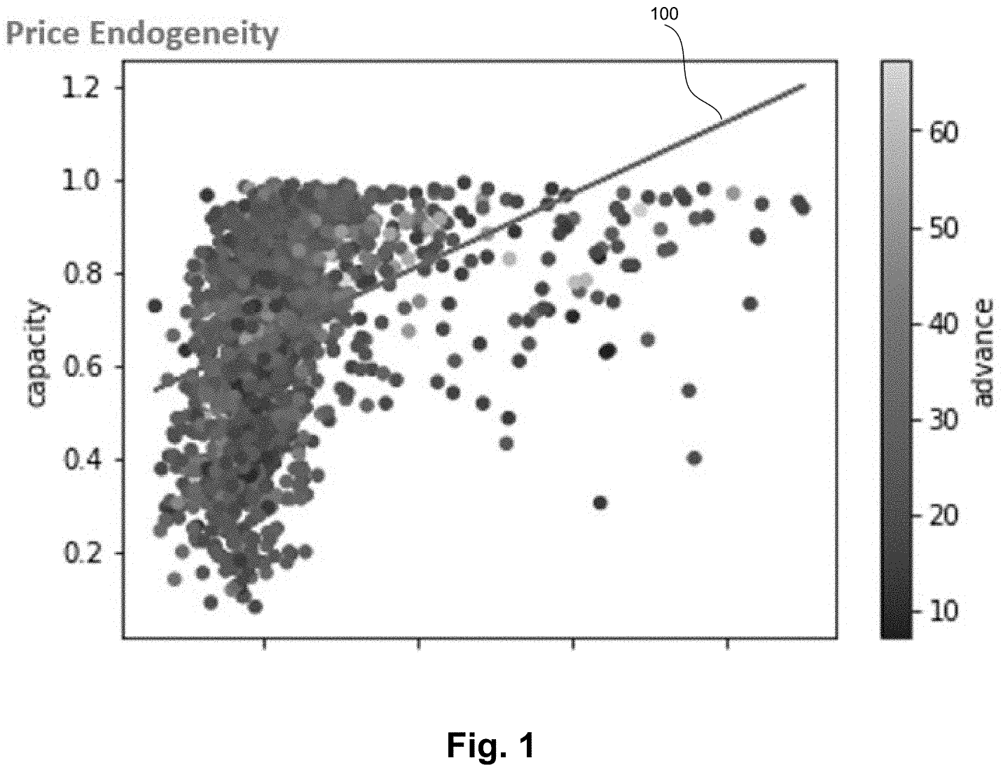

FIG. 1 is a graph that illustrates price endogeneity for hotel rooms. In FIG. 1, the X-axis represents average nightly room price, which is increasing from right to left. The Y-axis represents hotel booked capacity (occupancy), with 1.0 corresponding to 100% rooms being booked. With most goods and service, as prices are increased, demand decreases. However, as indicated by line 100, which has an upward slope (instead of an expected downward slope), for many hotels such as the example of FIG. 1, price endogeneity actually reflects rising demand as prices increase.

Known solutions in industries such as hotel, airline and retail, use an instrumental variables (“IV”) approach to correct for endogeneity. However, an IV approach requires the finding of a valid instrument, i.e., a variable that is correlated with the endogenous variable and uncorrelated with everything else. To estimate the demand for a particular product, instrumental variables can be selected as the costs of the components used in the manufacturing of the product. For example, the price index of alkaline and chlorines components as well as the price of plastic used for packaging as instrumental variables can be used in the analysis of the demand for laundry detergents. The general idea is that when prices of these components fluctuate, manufacturers would also adjust the prices of the final good (e.g., laundry detergent). However, the changes in the demand for the final good are not correlated with the component price changes.

If the demand system is modeled in such a way that price affects the outcome variable in a linear fashion, the IV approach can be used quite straightforwardly, with two-stage least squares (“2SLS”) regression being a common approach. Other approaches use discrete choice models that are more sophisticated and allow the demand model to capture interdependencies between the demands for different products that a firm offers. For example, in a hotel setting, different room types represent different alternatives that a customer may choose from when making a reservation, and the demand model may capture demand elasticity for a particular room type with respect to the changes in the price for other room type. Because in discrete choice models price influence the demand in a non-linear fashion, the 2SLS procedure cannot be applied and, depending on the model formulation, approaches such as “BLP” and control function may be used.

However, since an IV solution cannot be implemented without the valid instrumental variables, its practical application is limited by the fact that the appropriate instruments might be difficult to find, especially in the hospitality setting. In general, known solutions that correct for endogeneity all require use of instrumental variables. In some known solutions where IV is not used, the scope of the data required for estimation typically includes prices and detailed demand data for competitors, which is costly or even impossible to collect.

In contrast to known solutions of demand modeling for hotel rooms, embodiments add time shocks directly to the model, which accounts for the fact that these time shocks affect prices and demand simultaneously. Embodiments produce consistent estimates of the model parameters. The shocks themselves are not observable and are estimated together with the rest of the model parameters. The number of time periods that the dataset usually spans can be very large, and so would be the number of parameters to estimate if the model was estimated directly. Therefore, embodiments transform the original problem so that only a small number of parameters are estimated simultaneously, with all the time shock parameters being estimated in a subsequent separate step. Therefore, the computational power that is required to estimate the model is drastically reduced, which makes the application of the model very practical and improves the performance of the computer.

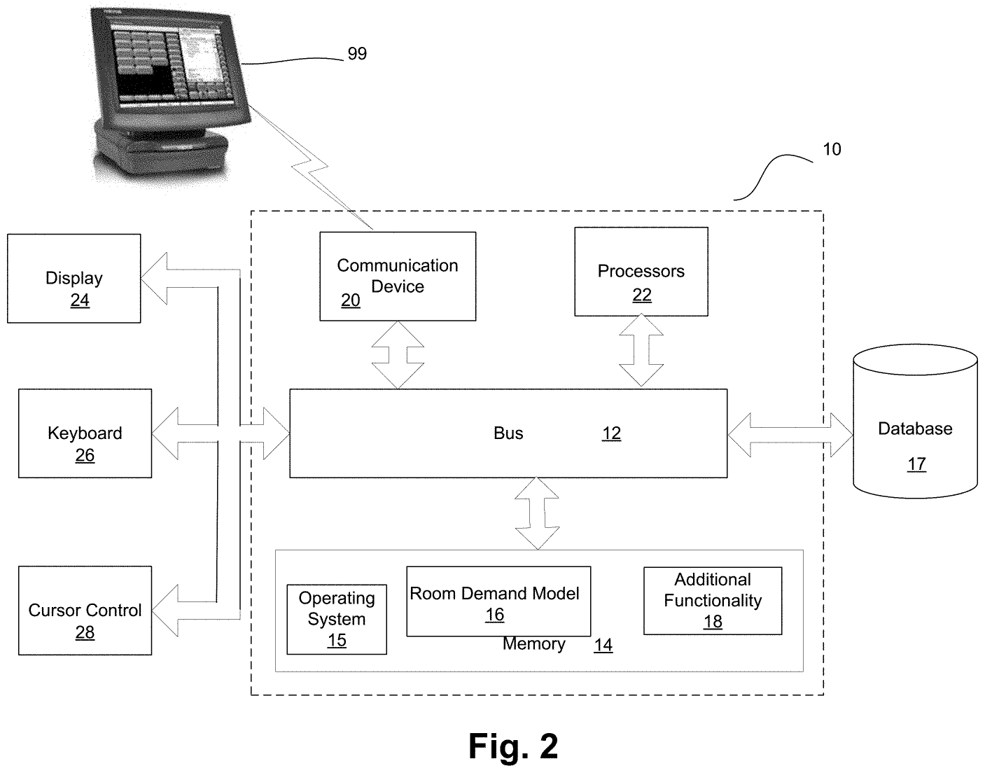

FIG. 2 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. For example, when implemented as a web server or cloud based functionality, system 10 is implemented as one or more servers, and user interfaces such as displays, mouse, etc. are not needed.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include room demand model module 16 that generates a room demand model to predict hotel room demand, maximize hotel room revenue, and all other functionality disclosed herein. System 10 can be part of a larger system. Therefore, system 10 can include one or more additional functional modules 18 to include the additional functionality, such as the functionality of a Property Management System (“PMS”) (e.g., the “Oracle Hospitality OPERA Property” or the “Oracle Hospitality OPERA Cloud Services”) or an enterprise resource planning (“ERP”) system. A database 17 is coupled to bus 12 to provide centralized storage for modules 16 and 18 and store guest data, hotel data, transactional data, etc. In one embodiment, database 17 is a relational database management system (“RDBMS”) that can use Structured Query Language (“SQL”) to manage the stored data. In one embodiment, a specialized point of sale (“POS”) terminal 99 generates transactional data and historical sales data (e.g., data concerning transactions of hotel guests/customers) used for performing the optimization. POS terminal 99 itself can include additional processing functionality to perform room assignment optimization in accordance with one embodiment and can operate as a specialized hotel room price optimization system either by itself or in conjunction with other components of FIG. 2.

In one embodiment, particularly when there are a large number of hotel locations, a large number of guests, and a large amount of historical data, database 17 is implemented as an in-memory database (“IMDB”). An IMDB is a database management system that primarily relies on main memory for computer data storage. It is contrasted with database management systems that employ a disk storage mechanism. Main memory databases are faster than disk-optimized databases because disk access is slower than memory access, the internal optimization algorithms are simpler and execute fewer CPU instructions. Accessing data in memory eliminates seek time when querying the data, which provides faster and more predictable performance than disk.

In one embodiment, database 17, when implemented as a IMDB, is implemented based on a distributed data grid. A distributed data grid is a system in which a collection of computer servers work together in one or more clusters to manage information and related operations, such as computations, within a distributed or clustered environment. A distributed data grid can be used to manage application objects and data that are shared across the servers. A distributed data grid provides low response time, high throughput, predictable scalability, continuous availability, and information reliability. In particular examples, distributed data grids, such as, e.g., the “Oracle Coherence” data grid from Oracle Corp., store information in-memory to achieve higher performance, and employ redundancy in keeping copies of that information synchronized across multiple servers, thus ensuring resiliency of the system and continued availability of the data in the event of failure of a server.

In one embodiment, system 10 is a computing/data processing system including an application or collection of distributed applications for enterprise organizations, and may also implement logistics, manufacturing, and inventory management functionality. The applications and computing system 10 may be configured to operate with or be implemented as a cloud-based networking system, a software-as-a-service (“SaaS”) architecture, or other type of computing solution.

As discussed above, correctly estimating underlying demand model for hotel rooms is an essential component of product recommendation and personalized pricing. If the estimated demand model coefficients are biased, it results in the suboptimal pricing of the hotel rooms and services and revenue loss for the hotel operators.

### Baseline MNL Demand Model

Embodiments first build a specialized Multinomial Logit (“MNL”). A standard known MNL model typically considers a consumer who has to make a choice out of a set of M alternatives plus an outside option. The consumer's utility from option i is Uᵢ=uᵢ−βpᵢ+ϵᵢ, where uᵢ is some deterministic component that can have multiple different parameters combined within it, β is this consumer's price sensitivity, and ϵ is some random component. The realization of the shock is unknown, but it is assumed it comes from a certain distribution. However, the consumer faces no information uncertainty when making a choice—an alternative is merely chosen that yields the maximum utility.

Let binary δⱼᵢ=1 if and only if person i chose product j and zero otherwise. The likelihood function that links consumer choice data with the parameters of the models is written as follows:

$$L = {\prod }_{i = 1}^{N} {\prod }_{j ∈ M} {( \frac{{e}^{{u}_{j} - β {p}_{j}}}{{\sum }_{k ∈ M} {e}^{{u}_{k} - β {p}_{k}}} )}^{{δ}_{ji}} \qquad ( 1 )$$

With the log-likelihood function as follows:

L=Σᵢ₌₁^{N}Σ_{j∈M}δⱼᵢ(uⱼ−βpⱼ−log(Σ_{k∈M}e^{u}^{ₖ}^{-βp}^{ₖ})) (2)

If the underlying model is specified correctly, then the parameters of the model can be consistently estimated by maximizing the likelihood function. However, the problem arises when there is some price endogeneity in the model. In the hotel context, the typical practice for the hotel manager is to increase prices when there are some positive demand shocks and decrease prices when demand is low, in order to attract customers. If the standard MNL model is estimated on the data with such endogeneity, the price sensitivity coefficient will be underestimated, and even might have a wrong sign. Further, even with prices completely exogenous, the estimation might still have a bias if there are some common shocks in the model, that affect utility of a group of customers simultaneously, even though that is usually less concerning than price endogeneity.

Embodiments therefore implement the following modification of a traditional MNL model to address the possible endogeneity/common shocks issue. In the following, to consider a hotel specific embodiment, “rooms” are used instead of the more generic “alternatives.” In other embodiments that are applicable to airplane seats, car rentals, or other date-constrained services, other terminology can be used.

The utility that a customer i looking for a room at time t gets from choosing some room j is:

Uᵢⱼₜ=uᵢ+βpⱼₜϵᵢⱼ+γₜ (3)

The utility from an outside option stays the same as in the MNL model, Uᵢ₀ₜ=u₀+ϵᵢ₀.

This way, consumers planning to travel on a certain date experience demand shocks that drive the demand for all the rooms in a proportional way. The ratio of the demand for any two alternatives have to stay the same if prices are unchanged across the periods. Specifically, if the usual demand for the first-class rooms is 100 units, and for suites is 4 units, this assumption means that if the demand for the first-class rooms increases up to 150 units, the demand for suites has to increase to 6 if prices are unchanged. Therefore, when determining such prices and utilities of rooms and taking in consideration changes in prices, the demand for different units would follow a proportional relationship.

### Likelihood Maximization

In one embodiment, likelihood maximization is used to estimate the MNL parameters. For simplicity, in embodiments it is assumed that all the customers arriving at time t observe the same prices, and, therefore, make the choice out of the same set of alternatives. Embodiments can further be extended to the case where each arriving customer observes different prices, as it usually happens in the hotel context, as disclosed below. Denote by yⱼₜ the number of customers arriving at time t who has chosen alternative j. Here it is important to distinguish between the rooms and the outside alternative, as the demand shock does not influence utility from the outside option. The likelihood function then has the following form:

$$L = {\prod }_{t = 1}^{T} ( {( \frac{{e}^{{u}_{0}}}{{e}^{{u}_{0}} + {\sum }_{k ∈ M} {e}^{{u}_{k} - β {p}_{kt} + {γ}_{t}}} )}^{{y}_{0 t}} \cdot {\prod }_{j ∈ M} {( \frac{{e}^{{u}_{j} - β {p}_{jt} + {γ}_{t}}}{{e}^{{u}_{0}} + {\sum }_{k ∈ M} {e}^{{u}_{k} - β {p}_{kt} + {γ}_{t}}} )}^{{y}_{jt}} ) \qquad ( 4 )$$

The log-likelihood function is as follows:

LL=Σₜ₌₁^{T}(y₀ₜ(u₀−log(e^{u}^{ₒ}+Σ_{k∈M}e^{u}^{ₖ}^{-βp}^{ₖₜ}^{+γ}^{ₜ}))+Σ_{j∈M}yⱼₜ(uⱼ−βpⱼₜ+γₜ−log(e^{u}^{ₒ}+Σ_{k∈M}e^{u}^{ₖ}^{-βp}^{ₖₜ}^{+γ}^{ₜ}))) (5)

Note that γₜ is not treated as a random coefficient, but as a deterministic but unknown parameter that has to be estimated.

It is known that u₀, . . . u_{M} can only be identified together up to a constant, so setting u₀=0 is a common normalization. However, in embodiments, u₁, . . . u_{M} and γ₁, . . . , γ_{T} also can only be identified together up to a constant. Specifically, if some constant is added to all γₜ and the same constant is subtracted from all uⱼ, ML will not change. Therefore, embodiments require one more normalization to identify the parameters of the model. Embodiments therefore assume that the sum of the time shocks (or, equivalently, their mean) has to be equal to 0, as the main interest is to identify u₁, . . . u_{M} and β, and if the average of the shocks is different from zero, that average should be attributed to the utilities u₁, . . . , u_{M}. Specifically, if the mean of the time shocks is positive, it would be strange to assume that there is some persistent positive demand shock, but rather that the true average utilities from the alternatives are higher.

Embodiments have M+T+1 parameters in the model to maximize the log-likelihood function over, which generally is not a scalable operation, especially when the T grows large. However, the optimization can be reduced down to solving a system of M (non-linear) equations in embodiments.

In embodiments, there are at least two different ways to ensure that γ₁+ . . . +γ_{T}=0. One is to rewrite one of the gammas (e.g., the first one) as a minus sum of all the others, and maximize the log-likelihood function with this substitution in place. However, this can be very tedious. Instead, embodiments just fix one of the utility parameters (e.g., u₁), at a certain value, and maximize the log-likelihood over all the other parameters, without enforcing γ₁+ . . . +γ_{T}=0. The estimated parameters u₂, . . . , u_{M} and γ₁, . . . γ_{T}, together with u₁, can be adjusted after the maximization is performed: to get the correct utilities, mean(γ) has to be added to u₁, . . . u_{M}, and subtracted from γ₁, . . . γ_{T}.

This above procedure is disclosed in more details as follows:

Denote sₜ=e^{u}^{₀}+Σ_{k∈M}e^{u}^{ₖ}^{-βp}^{ₖₜ}^{+γ}^{ₜ}. Also denote Nₜ=y₀ₜ+Σ_{j∈M}yⱼₜ, i.e., the total market size in period t.

$$\begin{matrix}L L = {\sum }_{t = 1}^{T} ( {y}_{0 t} ( {u}_{0} - log ( {s}_{t} ) ) + {\sum }_{j ∈ M} {y}_{j t} ( {u}_{j} - β {p}_{j t} + {γ}_{t} - log ( {s}_{t} ) ) ) \\ \frac{d L L}{d {γ}_{t}} = {\sum }_{j ∈ M} {y}_{j t} - {N}_{t} \frac{{\sum }_{k ∈ M} {e}^{{u}_{k} - β {p}_{k t} + {γ}_{t}}}{{s}_{t}} = {\sum }_{j ∈ M} {y}_{j t} - {N}_{t} \frac{{s}_{t} - {e}^{{u}_{0}}}{{s}_{t}} = 0 & ( 6 ) \\ {e}^{{γ}_{t}} = \frac{{e}^{{u}_{0}} {\sum }_{j ∈ M} {y}_{j t}}{{y}_{0 t} {\sum }_{k ∈ M} {e}^{{u}_{k} - β {p}_{k t}}} = \frac{{e}^{{u}_{0}}}{{\sum }_{k ∈ M} {e}^{{u}_{k} - β {p}_{k t}}} / \frac{{y}_{0 t}}{{\sum }_{j ∈ M} {y}_{j t}} & ( 7 )\end{matrix}$$

Equation (7) above has a very intuitive interpretation. If u₁, . . . u_{M} and β are known, the shocks y are derived as the ratio of the two ratios—the first one is the relative utility of the outside option to the utilities of all the other options, and the second is the proportion of demand that the outside option captured. When prices increase, the relative appeal of the outside option increases. If at the same time it is observed that the demand shares did not change, or if the outside option share decreases, this would be an evidence of the positive demand shock, and not the customers' insensitivity to prices.

If u₁, . . . , u_{M} and β are known, then plugging them into equation (5) above allows the estimates for the times shocks γₜ to be obtained. Therefore, embodiments focus on estimating the correct u₁, . . . , u_{M}, and more importantly β.

With this expression for γₜ some of the notations can be rewritten as follows:

$${s}_{t} = {e}^{{u}_{0}} + {\sum }_{k ∈ M} {e}^{{u}_{k} - β {p}_{k t} + {γ}_{t}} = {e}^{{u}_{0}} + {e}^{{γ}_{t}} {\sum }_{k ∈ M} {e}^{{u}_{k} - β {p}_{k t}} = \frac{{e}^{{u}_{0}} {N}_{t}}{{y}_{0 t}}$$

Taking the derivative with regard to uⱼ and substituting sₜ and e^{γ}^{ₜ} as derived above results in the following:

$$\frac{d L L}{d {u}_{j}} = {\sum }_{t = 1}^{T} {y}_{j t} - {N}_{t} \frac{{e}^{{u}_{j} - β {p}_{j t} + {γ}_{t}}}{{s}_{t}} = {\sum }_{t = 1}^{T} {y}_{j t} - \frac{{e}^{{u}_{j} - β {p}_{j t}} {\sum }_{k ∈ M} {y}_{k t}}{{\sum }_{k ∈ M} {e}^{{u}_{k} - β {p}_{k t}}} = 0 \qquad ( 8 )$$

Therefore, embodiments have M equations for j=1, . . . M of the following form:

$${\sum }_{t = 1}^{T} \frac{{y}_{j t} ( {\sum }_{k ∈ M} {e}^{{u}_{k} - β {p}_{k t}} ) - {e}^{{u}_{j} - β {p}_{j t}} ( {\sum }_{k ∈ M} {y}_{k t} )}{{\sum }_{k ∈ M} {e}^{{u}_{k} - β {p}_{k t}}} = 0 \qquad ( 9 )$$

From any (M−1) equations M-th would trivially hold, so in fact embodiments include only have M−1 equations that can be used to identify the parameters. Finally,

$$\frac{d L L}{d β} = {\sum }_{t = 1}^{T} \{ - ( {\sum }_{j ∈ M} {y}_{jt} {p}_{jt} ) - {N}_{t} \frac{{e}^{{γ}_{t}} {\sum }_{k ∈ M} {e}^{{u}_{k} - β {p}_{k t}} ( - {p}_{k t} )}{{s}_{t}} \} == {\sum }_{t = 1}^{T} \{ \frac{( {\sum }_{j ∈ M} {y}_{j t} ) {\sum }_{k ∈ M} {p}_{k t} {e}^{{u}_{k} - β {p}_{k t}}}{{\sum }_{k ∈ M} {e}^{{u}_{k} - β {p}_{k t}}} - {\sum }_{j ∈ M} {y}_{j t} {p}_{j t} \} = 0 \qquad ( 10 )$$

Together with the M−1 equations (9), embodiments now include M equations to estimate the M+1 parameter.

### Estimation Algorithm

The estimation algorithm for the baseline model (i.e., the model with every customer in time t facing the same choice set, which allows to aggregate model) can be summarized as follows:
1. Without the loss of generality, set u₁=0 (recall that u₀=0 was already normalized).
2. From equations (10) and (9), estimate u₂, . . . , u_{M}, β.
3. Given these estimates, calculate γₜ from equation (7).
4. Calculate μ=mean(γ₁, . . . γ_{T}). Adjust γₜ=γₜ−μ and uⱼ=uⱼ+μ for j=1,2, . . . M.

### Berkson-Theil Based Estimation

In another embodiment, the baseline model with time shocks (aggregate data, not individual choice) is estimated with the ordinary least squares minimization, instead of solving the system of equations disclosed above using likelihood maximization. This embodiment is based on the known “Berkson-Theil” method which is generalized and revised to include the time-specific demand shocks.

The estimation procedure in this embodiment is only asymptotically equivalent to the likelihood maximization, so it should be used only when the number of observations in each period is sufficiently high. Further, it can only be used if all categories in all time periods observe non-zero purchases, while likelihood maximization can handle cases with zero purchases for some product categories in some periods. Finally, as the baseline algorithm, this approach requires aggregate data.

As with the likelihood maximization embodiment, denote by yⱼₜ the number of customers who in period t chose product j. From multinomial logit it follows that:

$${y}_{jt} = {N}_{t} \times \frac{{e}^{{u}_{j} - β {p}_{j t} + {γ}_{t}}}{{e}^{{u}_{0}} + {\sum }_{k ∈ M} {e}^{{u}_{k} - β {p}_{k t} + {γ}_{t}}} \\ {y}_{0 t} = {N}_{t} \times \frac{{e}^{{u}_{0}}}{{e}^{{u}_{0}} + {\sum }_{k ∈ M} {e}^{{u}_{k} - β {p}_{k t} + {γ}_{t}}}$$

Therefore, for every yⱼₜ, j ∈ M, t=1, . . . , T the following is derived:

$$\frac{{y}_{j t}}{{y}_{0 t}} = {e}^{{u}_{j} - β {p}_{j t} + {γ}_{t} - {u}_{0}} \qquad ( 11 )$$

As u₀ is normalized to be 0, by taking logarithms on both sides and denoting \tilde{y}ⱼₜ=log(yⱼₜ)−log(y₀ₜ) a model is obtained that is linear in β, u and γ, so that OLS or weighted least squares can be applied to estimate the parameters of the model:

\tilde{y}ⱼₜ=log(yⱼₜ)−log(y₀ₜ)=uⱼ−βpⱼₜ+γₜ (12)

As with the likelihood maximization embodiment, u₁, . . . u_{M} and γₜ are not identified together, but the same normalization applies: Σₜ₌₁^{T}γₜ=0. Instead of imposing this restriction directly, embodiments fix u₁=0, estimate u₂, . . . , u_{M} and γ₁, . . . , γ_{T} from equation 12, calculate mean of γₜ and correct utilities by adding this statistics and correct γ by subtracting the statistic from each γₜ.

### Individual Choice

In embodiments that include some alternative room-specific parameters (e.g., room size, bed size (e.g., king/queen), water or city view, etc.) that need to be accounted for in the estimation, the above disclosed maximization of aggregate likelihood function can be used. However, in examples where there is data on some individual-specific parameters that needs to be accounted for in the estimation, an individual-choice likelihood function should be defined instead of the aggregate as in the equation (6) above. As disclosed above, δⱼₜᵢ=1 if consumer i chooses product j in period t and δⱼₜᵢ=0, otherwise. Since the availability of the panel data is not assumed here, every individual makes a choice only in one time period. However, keeping subscript t in δⱼₜᵢ helps to clarify in what period consumer i makes the choice. Therefore, it is preferred to keep this subscript even though it is not necessary.

Let xᵢ denote a vector (of length A) of characteristics of customer i, such as loyalty status, nationality etc. Assume that these characteristics enter utility function with some coefficients a that also has to be estimated. Further, different prices for every consumer are accounted for, so pⱼₜᵢ has subscript i too.

Denote by sᵢₜ=e^{u}^{₀}+Σ_{k∈M}e^{u}^{ₖ}^{-βp}^{ₖₜᵢ}^{+γ}^{ₜ}^{+αx}^{ᵢ}

LL=Σₜ₌₁^{T}Σ_{i∈N}_{ₜ}{δ₀ₜᵢ(u₀+αxᵢ−log(sₜᵢ))+Σ_{j∈M}δⱼₜᵢ(uⱼ+αxᵢ−βpⱼₜᵢ+γₜ−log(sₜᵢ))} (13)

In this embodiment, unlike in the aggregate likelihood function, first-order conditions on γ do not result in a closed-form expression, so γ can be substituted back into equation 13 and maximized with regards to M+A parameters only. In this case, all M+A+T parameters have to be estimated simultaneously. However, this embodiment can be used to propose “good” points to start with to ease the estimation procedure.

### Clustering

Since estimating ML with T+M(+A) parameters may be computationally difficult, an embodiment initially clusters customers on the basis of their booking and individual characteristics (such as nationality, loyalty status, length of stay, number of people in the party, number of children, etc.) instead of including customers into the model directly. With hard clusters (i.e., each customer belonging to one cluster only) the model is essentially divided into the separate markets, and the same efficient algorithm can be performed as on the aggregate data with just one cluster—first estimating parameters u and β without γ—as long as we assume that the time shocks are different for different clusters. u and β can be different or same for different clusters.

For the clustering embodiment, assume H clusters, and that every customer belongs to some cluster h ∈ H. For every product j there is yⱼₜ^{h}—the number of customers from cluster h who has bought product j in period t. Denote

$${s}_{t}^{h} = {e}^{{u}_{0}^{h}} + {\sum }_{j ∈ M} {e}^{{u}_{j}^{h} - {β}^{h} {p}_{j t} + {γ}_{t}^{h}} .$$

The log-likelihood function then can then be written as

Σₜ₌₁^{T}Σ_{h∈H}{y₀ₜ^{h}(u₀^{h}−log(sₜ^{h}))+Σ_{j∈M}yⱼₜ^{h}(uⱼ^{h}−β^{h}pⱼₜ+γₜ^{h}−log(sₜ^{h}))} (14)

As each γₜ^{h} only appears in one cluster term, the first-order conditions on γₜ^{h} have a closed-form solution as before:

$${e}^{{γ}_{t}^{h}} = \frac{{e}^{{u}_{0}^{h}} {\sum }_{j ∈ M} {y}_{j t}^{h}}{{y}_{0 t}^{h} {\sum }_{k ∈ M} {e}^{{u}_{k}^{h} - {β}^{h} {p}_{k t}}} = \frac{{e}^{{u}_{0}^{h}}}{{\sum }_{k ∈ M} {e}^{{u}_{k}^{h} - {β}^{h} {p}_{k t}}} / \frac{{y}_{0 t}^{h}}{{\sum }_{j ∈ M} {y}_{j t}^{h}} \qquad ( 15 )$$

This can be substituted into equation 15 so that the likelihood has to be maximized only with respect to M parameters instead of (M+T).

Any soft clustering procedure that results in probabilities for each individual belonging to cluster h ∈ H (including Gaussian clustering) needs to use the maximize likelihood function with regard to the M+T parameters.

### Regularization

With the penalty on magnitudes of parameters γₜ, the estimates of u₁, . . . , u_{M} and β approach the ordinary MNL estimates. Therefore, one embodiment adds some form of penalty on γₜ either to the aggregate or individual likelihood function. This ensures that the results do not differ significantly from MNL estimates in situations where there is a chance that the underlying model is misspecified. If such a penalty is added, there is no concern about joint identification of u₁, . . . u_{M} and γ₁, . . . , γ_{T}, as the penalty would ensure that all γs are as close to zero as possible. Note that the only difference here between the aggregate and individual log-likelihood (LL) functions is in the computing the total of the individual choices. While each observation in the aggregate data represents multiple identical individual choices, the non-identical individual choices cannot be aggregated into a single observation used in the individual LL function. Although conceptually there are no differences, the aggregate LL with time shocks is computationally easier to maximize than individual LL.

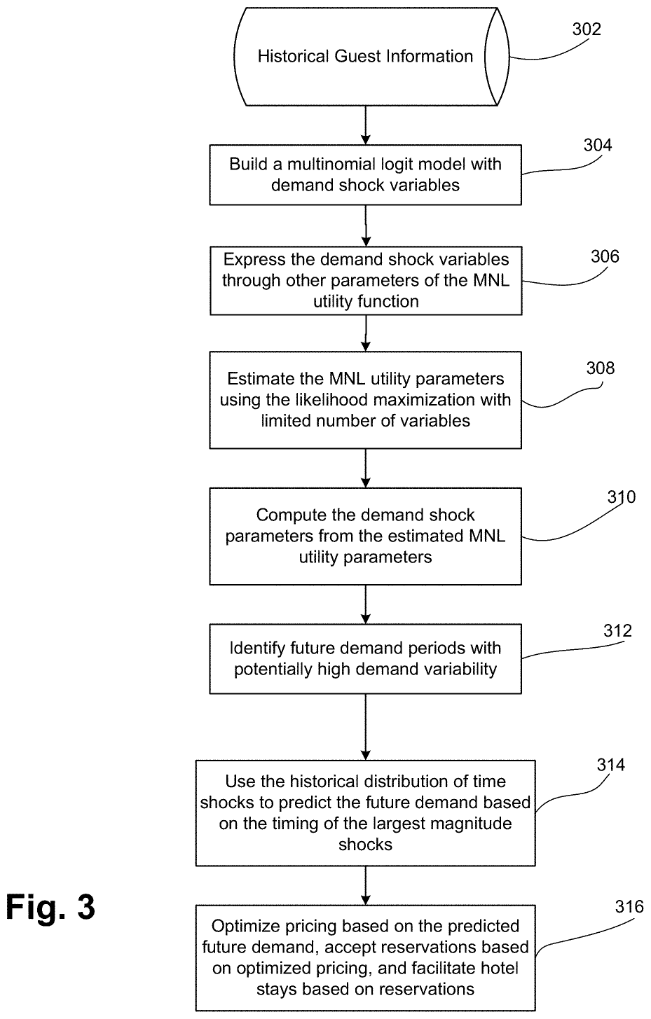

FIG. 3 is a flow diagram that illustrates the functionality of room demand model module 16 of FIG. 2 in accordance to embodiments. In one embodiment, the functionality of the flow diagram of FIG. 3 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 302, historical reservation data and guest information is received from an input dataset/database 17. In one embodiment, input dataset 17 is an “OPERA” database from Oracle Corp. and includes details on guests of a single hotel or a group of related hotels such as a chain of hotels as well as available rooms. In other embodiments, a database of data regarding guests and rooms for any type of PMS can be used. In embodiments, input dataset 17 is received via electronic communications from a computing device under the control of the hotel operator and is then parsed by system 10 to extract the information needed for the subsequent functionality disclosed below.

At 304, a multinomial logit model with demand shock variables is built. In one embodiment, the model is disclosed above in equation (5).

At 306, the demand shock variables are expressed through other parameters of the MNL utility function of equation (7).

At 308, the MNL utility parameters are estimated using the likelihood maximization with limited number of variables as specified by equations (9) and (10).

At 310, the demand shock parameters are computed from the estimated MNL utility parameters according to equation (7).

At 312, future demand periods with potentially high demand variability are identified.

At 314, the historical distribution of time shocks is used to predict the future demand based on the timing of the largest magnitude shocks. The demand for a future time period t is predicted according to the MNL discrete choice model where option j is selected with probability

$${P}_{j} = \frac{{e}^{{u}_{j} - β {p}_{j} + {γ}_{t}}}{{e}^{{u}_{0}} + {\sum }_{k ∈ M} {e}^{{u}_{k} - β {p}_{k} + {γ}_{t}}} .$$

Here, intercept parameters uₖ for the k-th choice and price sensitivity β are estimated according to the estimation algorithms of 308 described above. The time shock parameter γₜ is selected from the historic estimates for the similar demand periods computed at 310. For example, it could be a certain holiday period from the past years or a special event in the area known to attract large number of people from out of town.

At 316, pricing of the room categories is jointly optimized based on the relationship between the room prices and the demand for the rooms estimated at 314. In this case, the total revenue obtained from pricing room category j at price pⱼ is expressed as

$$( {p}_{1} , … , {p}_{m} ) = {\sum }_{j ∈ M} \frac{{e}^{{u}_{j} - β {p}_{j} + {γ}_{t}}}{{e}^{{u}_{0}} + {\sum }_{k ∈ M} {e}^{{u}_{k} - β {p}_{k} + {γ}_{t}}} .$$

Since the revenue is expressed as a closed-form function of the prices, it is possible to use any of the widely available function optimization packages based on the gradient search to find the optimal price set that would optimize the hotel revenue. Since the number of room categories is generally small, the potential issue of gradient-search procedure converging at the local maxima can be alleviated by choosing a grid of different starting points.

In response to the pricing, embodiments accept reservations based on optimized pricing, and facilitate hotel stays based on reservations. The optimized pricing may be stored in a database in the form of specialized data. Facilitating hotel stays can include transmitting the specialized data to other specialized devices that use the data such as using the data to operate a automatically device to encode hotel keys, using the data to automatically program hotel room door locks, etc.

In addition of the functionality of FIG. 3, embodiments use the determined optimal pricing to store and update databases that provide prices to online services. These updates can be frequent (e.g., multiple times a day or hour) and cause electronic devices to be automatically modified based on modified prices. Further, embodiments may cause hotels to be more fully utilized, thus resulting in additional services being used in the hotels. Further, embodiments cause the optimized prices to be sent over a network which causes other computing devices/servers to modify prices in a pricing database according to the revised optimized prices.

In a slightly different paradigm/embodiment commonly known as exploration-exploitation, the prices offered to some of the customers are randomly deviated from the optimal prices in order to improve the demand learning (exploration phase). It allows the model to be trained on the greater variety of the responses to obtain more robust coefficient estimations. After that, the new optimal prices are computed and offered through the booking system and the loop is reiterated. Each new customer response to the offer is stored in the database and used to retrain the model on the constant basis.

As a typical hotel chain obtains its bookings through multiple channels such as Global Distribution Systems (e.g., Amadeus), Online Travel Agencies (e.g., Expedia, Booking.com), Corporate Travel Management Companies (e.g., CWT, formerly Carlson Wagonlit Travel) as well as the hotel chain-operated channels such as voice, web and email booking, the embodiments of the invention are implemented to work with a variety of application programming interfaces (“API”), in order to make the collection of the booking data independent of the booking user hardware as much as possible. However, in order to expedite delivery of the personalized offers and recommendations provided by the invention to the hotel operators in some embodiments, the embodiments will be implemented to run on multiple hardware devices from hand-held mobile phones and computer pads to the desktop used by the booking agents.

### Comparison with MNL Model without Time Shocks

The following is a simulated comparison between a demand model based on a simple MNL model (referred to as “MNL”) and embodiments of the invention which integrate time shocks into an MNL (referred to as “TS”). Several prices/choices datasets are simulated to illustrate advantages of embodiments and show how robust embodiments are to various misspecifications of the model.

All the specifications disclosed below share the following common component: two products are modeled with utilities (u₁,u₂)=(6,8), β=−1, base prices for the two rooms in every period t are drawn from normal distribution with μ=(7,9) and

$$\sum = ( \begin{matrix}2 & 1 \\ 1 & 2\end{matrix} ) .$$

Further assumptions include T=20 periods and each period there are M=500 potential consumers. All consumers in the same period observe the same prices (can be relaxed). Time shocks γₜ are drawn from N(0,1), and all the consumers in period t experience the same shocks. The specifications below differ in how this shock influence utility the customer get from choosing each room—in the model it is assumed the shocks affect both rooms proportionally, but it is also determined what happens if the demand for one type of the room is not affected (or affected more than the other), to see how robust the estimations are to model misspecifications. The dependence of prices on the demand shocks y is also varied.

Denote base utility (without accounting for shocks γ) as u=(0, u₁, u₂). True parameters are u=(0,6,8). The true underlying model is νₜ=(0, u₁+γₜ, u₂+γₜ). Endogeneity in prices is set by assuming that at time t individuals observe price vector pₜ=(0, p₁ₜ+ƒ(γₜ), p₂ₜ+ƒ(γₜ)), where ƒ is usually a linear function of γ. The specifications used are as follows:

1. No endogeneity in prices+correct underlying model:
p=(0, p₁ₜ, p₂ₜ), νₜ=(0, u₁+γₜ, u₂+γₜ)

2a. Endogeneity in prices+correct underlying model:
p=(0, p₁ₜ+0.5γₜ, p₂ₜ+0.5γₜ), νₜ=(0, u₁+γₜ, u₂+γₜ)

2b. Endogeneity in prices+correct underlying model:
p=(0, p₁ₜ+0.5γₜ, p₂ₜ+γₜ), νₜ=(0, u₁+γₜ, u₂+γₜ)

3a. Endogeneity in prices+misspecified underlying model: shocks only affect demand for the first-class rooms:
p=(0, p₁ₜ+0.5γₜ, p₂ₜ+0.5γₜ), νₜ=(0, u₁+γₜ, u₂)

3b. Endogeneity in prices+misspecified underlying model: shocks affect demand for the first-class rooms twice as much as the demand for suites:
p=(0, p₁ₜ+0.5γₜ, p₂ₜ+0.5γₜ), νₜ=(0, u₁+2γₜ, u₂+γ)

4. No endogeneity in prices+misspecified underlying model: shocks only affect demand for the first-class rooms:
p=(0, p₁ₜ, p₂ₜ), νₜ=(0, u₁+γₜ, u₂)

5. No time shocks, no endogeneity in prices: This is just a safety check—to ensure that when there are no demand shocks, the model does not produce inappropriate results.

All estimations were averaged over 100 different samples, to exclude the possibility of the randomness in the samples causing bias in the estimations The results are shown in the Table 1 below.

TABLE 1
Comparison of
MNL and TS estimations

| Specification: | | u₁ | u₂ | β |
|---|---|---|---|---|
| 1 | MNL | 5.40 | 7.08 | −0.89 |
| 1 | TS | 5.94 | 7.92 | −0.99 |
| 2a | MNL | 4.35 | 5.43 | −0.75 |
| 2a | TS | 6.02 | 8.03 | −1.00 |
| 2b | MNL | 3.95 | 4.73 | −0.7 |
| 2b | TS | 6.00 | 8.02 | −1.00 |
| 3a | MNL | 4.33 | 5.42 | −0.74 |
| 3a | TS | 5.50 | 7.26 | −0.91 |
| 3b | MNL | 1.71 | 1.35 | −0.31 |
| 3b | TS | 4.48 | 5.68 | −0.73 |
| 4 | MNL | 5.46 | 7.00 | −0.90 |
| 4 | TS | 5.63 | 7.27 | −0.93 |
| 5 | MNL | 6.00 | 8.04 | −1.00 |
| 5 | TS | 6.03 | 8.04 | −1.00 |

As shown in the results of Table 1, even when prices are completely exogenous, MNL produces biased results because the assumption of independent ϵᵢⱼ is ruined by common demand shock introduction (specs 1 and 4). If the model is correctly specified (spec 1), TS performs better than MNL. If the model is misspecified (spec 4), both models produce similar (biased) results. Which one performs better in this case depends on how far away the specification is from the true underlying model.

Further, if the underlying model is correct, various prices endogeneity does not bias the estimates (specs 2a and 2b), while MNL is clearly significantly biased.

Further, when there is both endogeneity in prices and a misspecified model (specs 3a and 3b) anything could happen. From the estimations it appears that TS outperforms MNL a little, but this really depends on the magnitude of endogeneity and how misspecified the model is.

In embodiments, adding some regularization to the TS model can improve the performance. Specifically, adding a penalty (e.g., prior distribution on γ, RIDGE, or LASSO style) to the log-likelihood function. If the penalty is high enough, γ would be forced to zeros, and the estimates would approach those of the MNL model. In embodiments, some between estimates may perform better than the pure TS or the pure MNL model.

Further, embodiments are tested with an actual hotel demand dataset. Compared to the results of the simple MNL model that does not correct for price endogeneity, the estimations of price sensitivity coefficient in embodiments are up to 30% higher in magnitude.

As disclosed, embodiments accurately determined demand for hotel rooms (or other date-constrained services) by: (1) generating a novel model to account for price endogeneity that does not require instrumental variables; (2) Providing an easy transformation of the original problem that drastically reduces the number of parameters that has to be estimated simultaneously, and requires very little computational power; and (3) For the consistent estimation of the price sensitivity coefficient (and relative values of the room categories), not requiring knowledge of the number of no-purchase customers or even make any additional assumptions on the market size. Consistent estimation of the underlying demand model is crucial for price optimization, product recommendations, upsell recommendations, etc.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A method of modeling demand and pricing for hotel rooms, the method comprising:
receiving historical data regarding a plurality of previous guests;
generating a multinomial logit (MNL) model with demand shock variables, the demand shock variables expressed using MNL utility parameters;
estimating the MNL utility parameters using a likelihood maximization;
determining demand shock parameters using the estimating the MNL utility parameters; and
predicting a future demand of the hotel rooms based on the demand shock parameters.

2. The method of claim 1, further comprising:
based on the future demand, optimizing the pricing of the hotel rooms.

3. The method of claim 1, wherein the likelihood function comprises an aggregate likelihood function.

4. The method of claim 1, wherein the likelihood function comprises an individual-choice likelihood function.

5. The method of claim 1, the historical data comprising customer characteristics, the method further comprising clustering the character characteristics.

6. The method of claim 2, further comprising:
based on the future demand and the pricing, reserving a first hotel room for a first customer, and in response to the reserving, using a hotel room key machine to manufacture a room key that corresponds to the first hotel room.

7. The method of claim 1, wherein the determining demand shock parameters comprises:
$$\frac{d L L}{d {γ}_{t}} = {\sum }_{j ∈ M} {y}_{j t} - {N}_{t} \frac{{\sum }_{k ∈ M} {e}^{{u}_{k} - β {p}_{k t} + {γ}_{t}}}{{s}_{t}} = {\sum }_{j ∈ M} {y}_{j t} - {N}_{t} \frac{{s}_{t} - {e}^{{u}_{0}}}{{s}_{t}} = 0 \\ {e}^{{γ}_{t}} = \frac{{e}^{{u}_{0}} {\sum }_{j ∈ M} {y}_{j t}}{{y}_{0 t} {\sum }_{k ∈ M} {e}^{{u}_{k} - β {p}_{k t}}} = \frac{{e}^{{u}_{0}}}{{\sum }_{k ∈ M} {e}^{{u}_{k} - β {p}_{k t}}} / \frac{{y}_{0 t}}{{\sum }_{j ∈ M} {y}_{j t}} .$$

8. A computer readable medium having instructions stored thereon that, when executed by one or more processors, cause the processors to model demand and pricing for hotel rooms, the modeling comprising:
receiving historical data regarding a plurality of previous guests;
generating a multinomial logit (MNL) model with demand shock variables, the demand shock variables expressed using MNL utility parameters;
estimating the MNL utility parameters using a likelihood maximization;
determining demand shock parameters using the estimating the MNL utility parameters; and
predicting a future demand of the hotel rooms based on the demand shock parameters.

9. The computer readable medium of claim 8, the modeling further comprising:
based on the future demand, optimizing the pricing of the hotel rooms.

10. The computer readable medium of claim 8, wherein the likelihood function comprises an aggregate likelihood function.

11. The computer readable medium of claim 8, wherein the likelihood function comprises an individual-choice likelihood function.

12. The computer readable medium of claim 8, the historical data comprising customer characteristics, the modeling further comprising clustering the character characteristics.

13. The computer readable medium of claim 9, the modeling further comprising:
based on the future demand and the pricing, reserving a first hotel room for a first customer, and in response to the reserving, using a hotel room key machine to manufacture a room key that corresponds to the first hotel room.

14. The computer readable medium of claim 8, wherein the determining demand shock parameters comprises:
$$\frac{d L L}{d {γ}_{t}} = {\sum }_{j ∈ M} {y}_{j t} - {N}_{t} \frac{{\sum }_{k ∈ M} {e}^{{u}_{k} - β {p}_{k t} + {γ}_{t}}}{{s}_{t}} = {\sum }_{j ∈ M} {y}_{j t} - {N}_{t} \frac{{s}_{t} - {e}^{{u}_{0}}}{{s}_{t}} = 0 \\ {e}^{{γ}_{t}} = \frac{{e}^{{u}_{0}} {\sum }_{j ∈ M} {y}_{j t}}{{y}_{0 t} {\sum }_{k ∈ M} {e}^{{u}_{k} - β {p}_{k t}}} = \frac{{e}^{{u}_{0}}}{{\sum }_{k ∈ M} {e}^{{u}_{k} - β {p}_{k t}}} / \frac{{y}_{0 t}}{{\sum }_{j ∈ M} {y}_{j t}} .$$

15. A hotel room pricing system comprising:
one or more processors coupled to stored instructions; and
a database storing historical data regarding a plurality of previous guests;
the processors configured to model hotel room demand comprising:
generating a multinomial logit (MNL) model with demand shock variables, the demand shock variables expressed using MNL utility parameters;
estimating the MNL utility parameters using a likelihood maximization;
determining demand shock parameters using the estimating the MNL utility parameters; and
predicting a future demand of the hotel rooms based on the demand shock parameters.

16. The system of claim 15, the model hotel room demand further comprising:
based on the future demand, optimizing the pricing of the hotel rooms.

17. The system of claim 15, wherein the likelihood function comprises an aggregate likelihood function.

18. The system of claim 15, wherein the likelihood function comprises an individual-choice likelihood function.

19. The system of claim 16, further comprising:
a hotel room key machine;
the processors further configured to, based on the future demand and the pricing, reserving a first hotel room for a first customer, and in response to the reserving, using the hotel room key machine to manufacture a room key that corresponds to the first hotel room.

20. The system of claim 15, wherein the determining demand shock parameters comprises:
$$\frac{d L L}{d {γ}_{t}} = {\sum }_{j ∈ M} {y}_{j t} - {N}_{t} \frac{{\sum }_{k ∈ M} {e}^{{u}_{k} - β {p}_{k t} + {γ}_{t}}}{{s}_{t}} = {\sum }_{j ∈ M} {y}_{j t} - {N}_{t} \frac{{s}_{t} - {e}^{{u}_{0}}}{{s}_{t}} = 0 \\ {e}^{{γ}_{t}} = \frac{{e}^{{u}_{0}} {\sum }_{j ∈ M} {y}_{j t}}{{y}_{0 t} {\sum }_{k ∈ M} {e}^{{u}_{k} - β {p}_{k t}}} = \frac{{e}^{{u}_{0}}}{{\sum }_{k ∈ M} {e}^{{u}_{k} - β {p}_{k t}}} / \frac{{y}_{0 t}}{{\sum }_{j ∈ M} {y}_{j t}} .$$
